(19) United States
(12) Patent Application Publication
(10) Pub. No.: US 2012/0195186 A1
(43) Pub. Date: Aug. 2, 2012

(54) METHOD AND SYSTEM FOR PREVENTING TRAFFIC LOSS CAUSED BY WAIT-TO-RESTORE MECHANISMS IN SERVICE PROTECTION NETWORKS

(75) Inventors: Rajnath Singh, Richardson, TX (US); Guoliang Wu, Plano, TX (US); David Traylor, Allen, TX (US)

(73) Assignee: FUJITSU NETWORK COMMUNICATIONS, INC., Richardson, TX (US)

(21) Appl. No.: 13/360,265

(22) Filed: Jan. 27, 2012

Related U.S. Application Data
(60) Provisional application No. 61/438,116, filed on Jan. 31, 2011.

(51) Int. Cl. H04L 12/26

(52) U.S. Cl. 370/217

(57) ABSTRACT

A method for preventing traffic loss includes transmitting user traffic over an automatic protection switching (“APS”) connection with revertive operation between a first switch and a second switch, determining that the working path on the APS connection has failed, moving user traffic to the protect path of the APS connection, and initiating a wait-to-restore mode including a wait-to-restore time period associated with the first switch. The method also includes, upon termination of the wait-to-restore time period of the first switch, maintaining traffic on the protect path until a message designating the working path is received on the protect path. The method further includes, upon receiving a message designating the working path, switching user traffic to the working path. The APS connection includes the protect path and the working path.

### RELATED APPLICATION

This application claims the benefit under 35 U.S.C. §119(e) of U.S. Provisional Application Ser. No. 61/438,116 filed Jan. 31, 2011, entitled “METHOD AND SYSTEM FOR PREVENTING TRAFFIC LOSS CAUSED BY WAIT-TO-RESTORE MECHANISMS IN SERVICE PROTECTION NETWORKS.”

### TECHNICAL FIELD OF THE INVENTION

The present invention relates generally to networked communications and, more particularly, to a method and system for preventing traffic loss caused by wait-to-restore mechanisms in service protection networks.

### BACKGROUND

Ethernet automatic protection switching under the G.8031 standard may use protected paths, one active and one backup, to communicate between virtual local area networks. The paths are monitored, and if one of the paths is detected as faulty, the backup path may take over and traffic continues to flow. The G.8031 standard has heretofore dictated the specific protocol for switching traffic between the paths in a variety of circumstances.

### SUMMARY

In one embodiment, a method for preventing traffic loss includes transmitting user traffic over an automatic protection switching (“APS”) connection with revertive operation between a first switch and a second switch, determining that a working path on the APS connection has failed, moving user traffic to a protect path of the APS connection, and initiating a wait-to-restore mode including a wait-to-restore time period associated with the first switch. The method also includes, upon termination of the wait-to-restore time period of the first switch, maintaining traffic on the protect path until a message designating the working path is received on the protect path. The method further includes, upon receiving a message designating the working path, switching user traffic to the working path. The APS connection includes the working path and the protect path.

In another embodiment, an article of manufacture includes a computer readable medium and computer-executable instructions carried on the computer readable medium. The instructions are readable by a processor. The instructions, when read and executed, cause the processor to transmit user traffic over an APS connection with revertive operation between a first switch and a second switch. The APS connection includes a working path and a protect path. The instructions further cause the processor to determine that the working path on the APS connection has failed, move user traffic to the protect path of the APS connection, and initiate a wait-to-restore mode including a wait-to-restore time period associated with the first switch. The instructions further cause the processor to, upon termination of the wait-to-restore time period of the first switch, maintain traffic on the protect path until a message designating the working path is received on the protect path. Upon a message designating the working path, the instructions cause the processor to switch user traffic to the working path.

In yet another embodiment, a system includes a first switch that includes a computer readable medium and a processor coupled to the computer readable medium, an automatic protection switching connection communicatively coupled to the first switch, and computer-executable instructions carried on the computer readable medium. The instructions are readable by the processor. The instructions, when read and executed, cause the processor to transmit user traffic over an APS connection with revertive operation between a first switch and a second switch. The APS connection includes a working path and a protect path. The instructions further cause the processor to determine that the working path on the APS connection has failed, move user traffic to the protect path of the APS connection, initiate a wait-to-restore mode including a wait-to-restore time period associated with the first switch, maintain traffic on the protect path upon termination of the wait-to-restore time period of the first switch until a message designating the working path is received on the protect path, and, upon receiving a message designating the working path, switch user traffic to the working path.

### BRIEF DESCRIPTION OF THE DRAWINGS

For a more complete understanding of the present invention and its features and advantages, reference is now made to the following description, taken in conjunction with the accompanying drawings, in which:

FIG. 1 is an example embodiment of a system for preventing traffic loss caused by wait-to-restore mechanisms in service protection networks;

FIG. 2 is an example illustration of the state transition operation of an example switch implementing a transition table;

FIG. 3 is an example illustration of the operation of the system for preventing traffic loss caused by wait-to-restore mechanisms in service protection networks; and

FIG. 4 is an example embodiment of a method for preventing traffic loss caused by wait-to-restore mechanisms in service protection networks.

### DETAILED DESCRIPTION

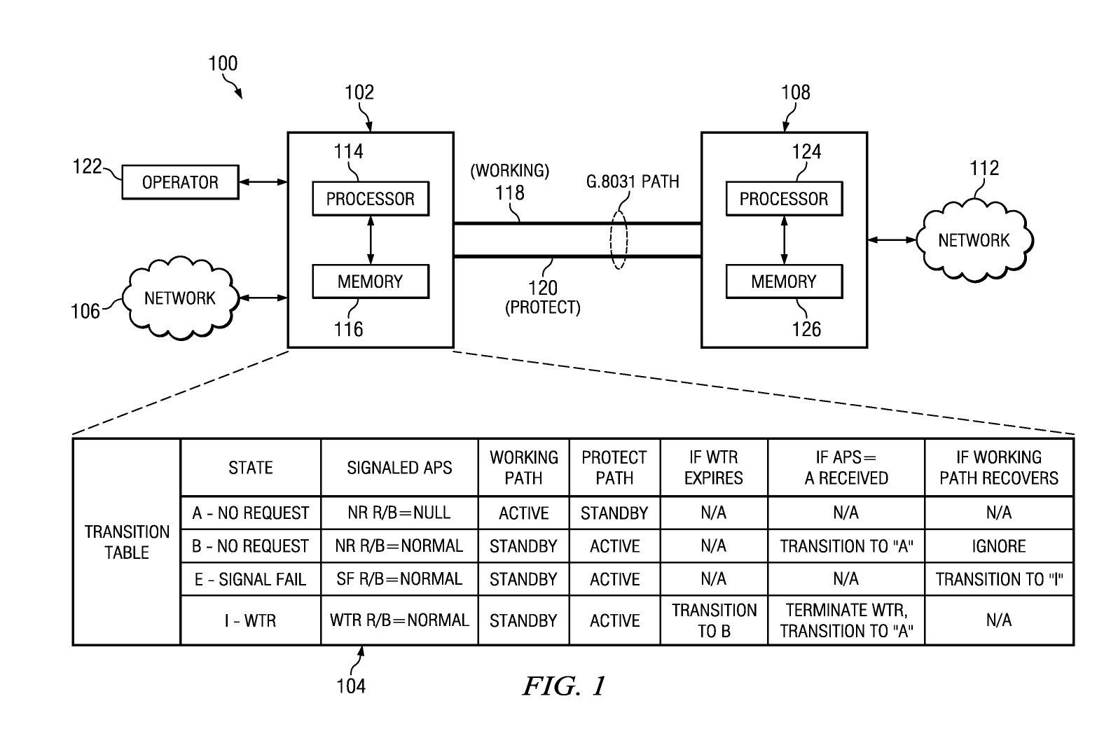

FIG. 1 is an example embodiment of a system 100 for preventing traffic loss caused by wait-to-restore mechanisms in service protection networks. System 100 may include a network entity such as switch 102 communicatively coupled to a network entity such as a second switch 108. In one embodiment, system 100 may be configured to prevent traffic loss caused in a revertive, one-to-one linear protection network with bidirectional wait-to-restore mechanisms in switch 102 and switch 108. In another embodiment, system 100 may be configured to prevent traffic loss in G.8031 service protection networks. In yet another embodiment, system 100 may be configured to prevent traffic loss caused by wait-to-restore (“WTR”) mechanisms in either switch 102, 108 occurring during networked communication between the two when switch 102 and switch 108 have different WTR timers, or initiate WTR periods at different times.

The network of system 100 may include switches 102, 108 coupled to other networks or sub-networks. In one embodiment, network 106 may be coupled to switch 102. In another embodiment, network 112 may be coupled to switch 108. Network 106 may comprise any suitable network—for example, a local-area-network, wide-area-network, a network of metro Ethernet switches, virtual-local-area-network, an intranet, or a portion of the Internet. Network 112 may comprise any suitable network—for example, a local-area-network, wide-area-network, a network of metro Ethernet switches, virtual-local-area-network, an intranet, or a portion of the Internet. System 100 may be configured to transport information between network entities coupled to switch 102 and network entities coupled to switch 108. Additional network entities may be coupled between switch 102 and switch 108. Such additional network entities may include a local-area-network, wide-area-network, a network of metro Ethernet switches, virtual-local-area-network, an intranet, or a portion of the Internet.

System 100 may include an operator 122 communicatively coupled to one or more portions of the network of system 100, such as switch 102. In one embodiment, operator 122 may include an electronic device configured to receive information about the operation of system 100. In another embodiment, operator 122 may include an electronic device configured to make changes in system 100 in response to information about the operation of system 100. Operator 122 may be configured to make some of such changes automatically. Operator 122 may include interfaces for a human administrator of the system 100 to receive information regarding the operation of system 100, and to enter desired changes in system 100 in response to the information.

Switch 102 may include a processor 114 coupled to a memory 116. Processor 114 may comprise, for example, a microprocessor, microcontroller, digital signal processor (DSP), application specific integrated circuit (ASIC), or any other digital or analog circuitry configured to interpret and/or execute program instructions and/or process data. Switch 102 may interpret and/or execute program instructions and/or process data stored in memory 116. Memory 116 may comprise any system, device, or apparatus configured to hold and/or house one or more memory modules. Each memory module may include any system, device or apparatus configured to retain program instructions and/or data for a period of time (e.g., computer-readable media).

In one embodiment, switch 108 may include a processor 124 coupled to a memory 126. Processor 124 may comprise, for example, a microprocessor, microcontroller, digital signal processor (DSP), application specific integrated circuit (ASIC), or any other digital or analog circuitry configured to interpret and/or execute program instructions and/or process data. Switch 108 may interpret and/or execute program instructions and/or process data stored in memory 126. Memory 126 may comprise any system, device, or apparatus configured to hold and/or house one or more memory modules. Each memory module may include any system, device or apparatus configured to retain program instructions and/or data for a period of time (e.g., computer-readable media).

Switch 102 and switch 108 may include other network entities, not shown, which may be configured to carry on the communications described herein. Switch 102 and switch 108 may each contain multiple of such network entities. One example of such network entities may be a logical grouping of resources of the switch into a service group. The configuration and operations of switch 102 and switch 108 described here may be implemented in such logical groupings.

Switch 102 and switch 108 may communicate using linear protected switching. Switch 102 and switch 108 may be communicatively coupled through a linearly protected switching connection. The linearly protected switching connection may comprise a protected path. In one embodiment, the protected path may comprise a G.8031 protected path. In a further embodiment, the protected path may comprise a working path 118 and a protect path 120. Switch 102 and switch 108 may be communicatively coupled over working path 118 and protect path 120. One of paths 118, 120 may be designated as active, wherein a switch monitoring the paths 118, 120 for inbound traffic will accept packets from the active path and simply drop data packets from the other path, but still accept control packets required for the operation of a path protection protocol such as G.8031. In one embodiment, the working path 118 may be initially configured as the active path. If working path 118 is down or otherwise unavailable, then protect path 120 may be configured as the active path.

Switch 102 and switch 108 may communicate using linear protected switching. Switch 102 and switch 108 may be communicatively coupled through a linearly protected switching connection. The linearly protected switching connection may include a protected path. In one embodiment, the protected path may form a portion of a G.8031 protected path. In a further embodiment, the protected path may comprise a working path 118 and a protect path 120. Each of working path 118 and protect path 120 may include routes through a number of network entities between switch 102 and switch 108. Each of working path 118 and protect path 120 may include two transmission media. Such transmission media may include any suitable media such as fiber or copper. In one embodiment, two of such transmission media may form a transmission tunnel and a reception tunnel for each switch 102, 108. One of paths 118, 120 may be designated as active, wherein a switch using paths 118, 120 for user traffic will transmit and receive packets making up the user traffic over the active path, but ignore such user traffic on the other path. User traffic may include user traffic originating and travelling to destinations in network 106 and network 112. User traffic may flow on working path 118 or protect path 120, depending upon the configuration of switches 102 and 108. Such a configuration may determine which of the paths is active and thus carrying user traffic. The switch may continue to monitor the protection path 120 for control and status messages, such as automatic protection switching (“APS”) messages. APS messages may implement a control packet. APS messages may include protocol messages. APS messages may include property and state information of an originating switch. APS messages may be exchanged using the protect path 120. In one embodiment, the working path 118 may be initially configured as the active path. If working path 118 is down or otherwise unavailable, then protect path 120 may be configured as the active path for user traffic. In another embodiment, switch 102 and switch 108 may exchange user traffic over the active path, but only exchange APS messages over protect path 120. In such an embodiment, if protect path 120 is unavailable then APS messages may be lost. APS messages and user traffic may thus be able to be transmitted at times on the same protect path 120. System 100 may thus be configured to transport user traffic between various networked entities in system 100, such as between those in network 106 and in network 112. Switches 102, 108 may be configured to operate in pre-determined states of operation, depending upon the conditions encountered. Pre-determined states of operation may indicate any suitable information about operational settings or conditions encountered. For example, pre-determined states of operation may indicate to switches 102, 108 which path 118, 120 should be used for communication given the occurrence of a particular event.

Switch 102 may be configured to store pre-determined states of operation in transition table 104. Transition table 104 may include any suitable number of pre-determined states. Transition table 104 may contain indications, for each state, of what actions should be taken given any number of conditions observed. Transition table 104 may be stored in memory 116. For example, transition table 104 may include, among others, states “A,” “B,” “E,” and “I.” State “A” may indicate normal operation wherein communication between two switches is conducted on working path 118 with protect path 120 on standby. State “B” may indicate an operation wherein communication between two switches is conducted on protect path 120 with working path 118 on standby. State “E” may indicate that an error has occurred while communicating on the working path 118. State “I” may indicate operations to be conducted while a switch is in wait-to-restore mode.

Switch 102 and switch 108 may be configured to periodically exchange APS messages. Such messages may be exchanged one-for-one, and in both directions. Such APS messages may contain information pertaining to the status, state, and operation of a switch to be communicated to another switch.

Network 100 may utilize one-to-one linear protection as implemented by switch 102 and switch 108. In such a case, user traffic may be transmitted on either part of a protected path, such as working path 118. However, user traffic may not be transmitted on both sides of the path, such as on both working path 118 and protect path 120. If one of switches 102, 108 attempts to transmit user traffic on working path 118 and the other attempts to transmit user traffic on protect path 120, both switches will not receive the other end's traffic, and the traffic may be lost.

Upon detection of a loss in user traffic, switch 102 and switch 108 may be configured to switch to a different pre-determined state of operation based upon the conditions encountered. Such a state of operation may include directives that the switch move user traffic to an alternative path. For example, if switch 102 and switch 108 are communicating user traffic over working path 118, and communication over the working path 118 fails, upon detection or notification of the failure the switch may enter a state such as “E.” State “E” may be implemented according to the G.8031 standard, with APS signaling of “SF r/b=normal” wherein the working path is set as a standby and the protect path is set as active. Thus, as part of operation of the state, switch 102 and switch 108 may be configured to move user traffic to protect path 120.

In one embodiment, system 100 may be configured to use revertive protection. In such an embodiment, switch 102 and switch 108 may include wait-to-restore (“WTR”) mechanisms such as states or timers. System 100 may be configured to determine whether transmission of user traffic is once again possible on working path 118, and after a delay after such a determination may switch transmission of user traffic back on working path 118. Switch 102 and switch 108 may be configured to determine whether the failed transmission path such as working path 118 has recovered. In one embodiment, switch 102 and switch 108 may nearly contemporaneously determine that the transmission path has recovered. Once it has been determined that the failed transmission path has recovered, switch 102 and switch 108 may enter into a WTR state. In a WTR state, a switch may be configured to wait a designated period of time before returning user traffic to the original path. The WTR timer period of the switch may be variable, and may vary from switch to switch.

For example, switch 102 and switch 108 may determine that the working path 118 has recovered. Switch 102 and switch 108 may each enter a WTR state. Switch 102 may have a WTR period of five minutes, after which according to the G.8031 specification switch 102 will resume communicating traffic on working path 118 instead of protect path 120. Switch 102 may thus return to a state indicating normal transmission, such as state “A”. State “A” may be implemented according to the G.8031 standard, wherein the state has no request, the working path is active, and the protect path is on standby. Signaled APS may be in the mode [NR r/b=null]. Switch 102 may be configured to send an APS message indicating its new state to switch 108 on the protected path 120. However, switch 108 may have a WTR period of eight minutes, after which according to the G.8031 standard switch 108 would resume communicating user traffic on working path 118 instead of protect path 120. Switch 108 may then return to a state indicated normal transmission such as a state “A.” However, in this example during the roughly three minutes after switch 102 has returned to transmitting user traffic on the working path 118, switch 108 may continue to transmit user traffic on protect path 120, until the WTR timer of switch 108 expires and switch 108 transmits user traffic instead on working path 118. Without any additional action, during this time user traffic between switch 108 and switch 102 may be lost.

Switches in system 100 may have different WTR values for several reasons. For example, switch 102 and switch 108 may belong to different network administrators. In another example, switch 102 and switch 108 may not be coordinating operations. In addition, one switch may detect a restoration of working path 118 substantially before the other switch. In such a case, even if the two switches have the same WTR period the effect may be similar to the case where the two switches have very different WTR periods, since one switch will begin its countdown sooner than the other.

In one embodiment, when a switch such as switch 102 or switch 108 generates a WTR expiration event, and the switch has not received any indication from the other switch that the other switch has experienced a WTR transition or otherwise changed states, then the switch generating the expiration event may be configured to transition to a state to maintain current communication, rather than change to a state that would switch the active path. However, such a state may still indicate that the WTR period is no longer active. In such an embodiment, the switch may not use the G.8031 standard transition to state “A.” For example, switch 102 may implement a state “I” as shown in transition table 104. Switch 102 may be configured to transmit APS signals indicating “WTR r/b=normal” while setting the protect path as active and the working path in standby. If switch 102 generates a WTR expiration event after five minutes and has not received any indication from switch 108 that switch 108 has moved to another state, then switch 102 may transition to state “B” instead of state “A.” State “B” may be implemented according to the G.8031 standard, wherein the state has no request, the working path is in standby, and the protect path is active. Signaled APS may be in the mode [NR r/b=normal]. Thus, traffic will continue to be delivered to switch 108 on the protect path 120, which presumably switch 108 is using since its WTR timer has not yet finished.

In another embodiment, switch 102 may receive an APS message from switch 108 indicating a particular active state for switch 108. For example, switch 102 may receive an APS message from switch 108 indicating that switch 108 has moved into state “A,” implying that it has moved traffic to working path 118. In such an embodiment, switch 102 may be configured to move to the particular active state indicated in the APS message that was received. Switch 102 may terminate its WTR timer countdown and move to the indicated state. Thus, switch 102 may be able to react to termination of WTR in switch 108 that occurs before switch 102 finishes its own WTR period.

In one embodiment, switch 108 may be implemented with the transition table 104. In another embodiment, switch 108 with a different transition table, such as one conforming only to the G.8031 standard. By transitioning to an operation state that maintains the active path when receiving a WTR expiration event, or by transitioning to another state indicated in a received APS message, switch 102 may thus be configured to prevent a loss in communication even if the operation of switch 108 does not implement transition table 104. For example, switch 108 may be limited to operation under the G.8031 standard only. In various embodiments, switch 108 may be provided by a third party, and its operation above and beyond the G.8031 standard cannot be verified or assumed.

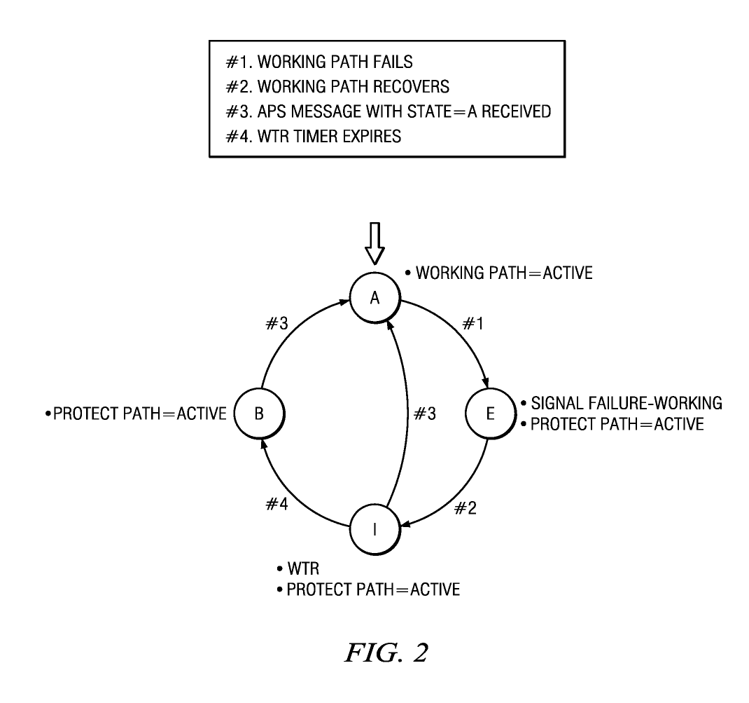

The state transition operation of an example switch implementing the transition table 104 may be illustrated in FIG. 2. Assuming an initial operation of state “A,” a failure of working path 118 may trigger a transition to state “E.” There, once working path 118 recovers the operation may be transitioned to state “I,” a WTR state. If an APS message with a state “A” designation is received from another switch, operation may be transitioned back to state “A” and the WTR operation terminated. However, if the WTR countdown terminates before such a message is received, operation may be transitioned to state “B.” In state “B,” if an APS message with a state “A” designation is received from another switch, operation may be transitioned back to state “A.”

In operation, switch 102 and switch 108 may be communicating through working path 118. Switch 102 may be operating in state “A” according to the transition table 104. A signal failure in working path 118 may cause switch 102 to transition to state “E” according to the transition table 104. In state “E,” switch 102 may wait for the error in working path 118 to finish. Meanwhile, switch 102 and switch 108 may communicate traffic through protect path 120. If switch 102 detects that working path 118 has recovered, then switch 102 may begin a WTR countdown. Switch 102 may enter state “I” according to the transition table 104.

In various embodiments, switch 108 may or may not have also operated originally in state “A,” transitioned to state “E” upon a signal failure of working path 118, detected that working path 118 recovered and then entered into state “I” according to the transition table 104. In one embodiment, the operation of switch 108 may be limited to operation according to the G.8031 standard. In another embodiment, the operation of switch 108 after entering into a WTR state might not be implemented in the transition table 104, and switch 108 may not enter the state “I” of transition table 104. In yet another embodiment, switch 108 may implement the transition table 104, and its operation may mirror that of switch 102.

Switch 102 may monitor working path 118, may transmit traffic on protect path 120, and may wait until either its WTR period terminates or until it receives an APS message from switch 108 designating that switch 108 is in state “A.” Such a message may be received on protect path 120. Working path 118 may be available for switch 102 to be monitored because switch 102 waited until the path had recovered before entering its WTR countdown phase.

If the switch 102 receives a message on working path 118 designating another state as active from switch 108, then switch 102 may transition to that state. For example, switch 102 may receive a message from switch 108 designating switch 108 to be operating in state “A,” and switch 102 may follow suit by transitioning to state “A” and terminating its WTR operation. If the WTR period ends before receiving such a message, switch 102 may enter a state that maintains communication on protect path 120, but communicates that its WTR period has ended. For example, switch 102 may enter state “B” according to transition table 104. Switch 102 may send APS messages indicating state “B” to switch 108. Switch 102 may continue to monitor for an APS message from switch 108 designating that switch 108 is in state “A,” or that switch 108 is otherwise using the working path 118 for user traffic.

If switch 102 receives an APS message from switch 108 designating that switch 108 is in state “A,” then switch 102 may transition to state “A.” In doing so, switch 102 may then use working path 118 to transmit user traffic and set protect path 120 as a standby.

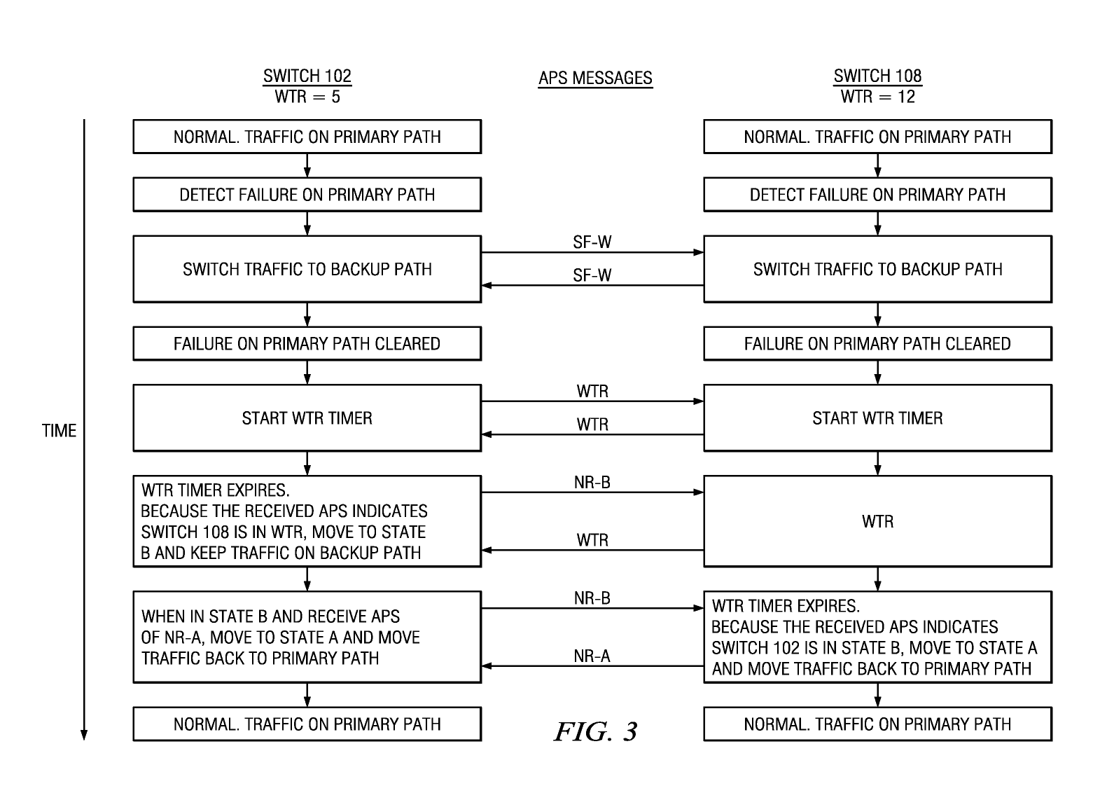

FIG. 3 is an example illustration of the operation of system 100 for preventing traffic loss caused by wait-to-restore mechanisms in service protection networks with two example network entities represented by switch 102 and switch 108. In the example, switch 102 has a WTR period of 5 minutes and switch 108 has a WTR period of 12 minutes. At the beginning, user traffic may be transported between the switches on a primary path. Such a primary path may be a working path of a G.8031 connection. Next, each switch may detect a failure on the primary path. Each switch may switch user traffic to the backup path. Such a backup path may be a protect path of a G.8031 connection. Each switch may send an “SF-W” APS message to the other switch indicating that a signal failure on the working path has been detected.

The detected failure on the primary path may be cleared, and each switch may start its respective WTR timer. As a result, each switch may send a “WTR” APS message to the other switch indicating that the switch is operating within the WTR state.

The WTR timer of switch 102 may expire, and switch 108 may still be operating in the WTR state. Switch 108 may thus continue to send a “WTR” APS message to switch 102. Because switch 102 receives this “WTR” message from switch 108, switch 102 may move to state “B” and keep its user traffic on the backup path. Switch 102 may send a “NR-B” APS signal to switch 108, indicating the state that switch 102 is in.

The WTR timer of switch 108 may then expire. Because the received “NR-B” APS signal from switch 102 indicates that switch 102 is in state B, switch 108 may move user traffic to primary path and move to state “A.” Switch 108 may send an “NR-A” APS in reply to switch 102. Switch 102 may receive the “NR-A” signal from switch 108 and may move user traffic to primary path. Switch 102 may move to state “A.”

As a result, both switches may be operating by sending user traffic on the primary path.

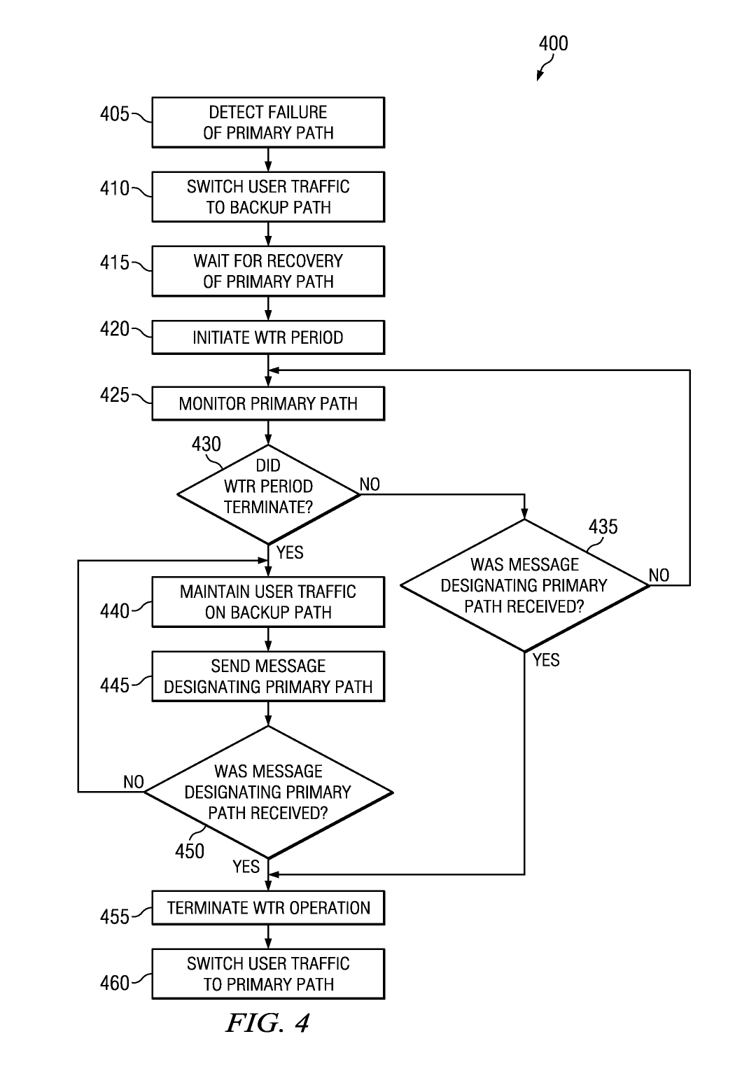

FIG. 4 is an example embodiment of a method 400 for preventing traffic loss caused by wait-to-restore mechanisms in service protection networks. During electronic communication, in step 405 failure of a primary path may be detected. Such a primary path may be a working path of a G.8031 connection. In step 410, traffic associated with the communication may be moved to a backup path. Such a backup path may be a protect path of a G.8031 connection. The recovery of the primary path may be waited for in step 415. In step 420, a wait-to-restore period may be initiated. In step 425, the primary path may be monitored for communication or updates.

In step 430, it may be determined whether the wait-to-restore period has terminated. If so, method 400 may proceed to step 440. If not, in step 435 it may be determined whether a message designating the primary path has been received on the primary path. In one embodiment, in step 435 it may be determined whether a message has been received that indicates that another entity has finished a wait-to-restore period. If not, then step 430 may be repeated.

In step 440, if the wait-to-restore period has terminated, communication on backup path may be maintained. Messages designating or implying that the wait-to-restore period is over may be transmitted on the backup path in step 445. Such messages may designate a move of user traffic to the primary path. In step 450, some or all portions of step 435 may be repeated, except that if such messages are not received, the method 400 may then repeat the steps beginning with maintaining user traffic communication on the backup path in step 440.

If in step 435 or in step 450 it was determined that a message designating the primary path was received or designating that another entity has finished a wait-to-restore period, in step 455 the WTR operation may be terminated, if necessary. In step 455 user traffic communication may be switched to the primary path.

The steps of method 400 may be conducted in parallel by different entities implementing method 400.

Although FIG. 4 discloses a particular number of steps to be taken with respect to an example method 400, method 400 may be executed with more or fewer steps than those depicted in FIG. 4. In addition, although FIG. 4 discloses a certain order of steps to be taken with respect to method 400, the steps comprising method 400 may be completed in any suitable order.

Method 400 may be implemented using the system of FIGS. 1-3 or any other system, network, or device operable to implement method 400. In certain embodiments, method 400 may be implemented partially or fully in software embodied in computer-readable media.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, and other electromagnetic and/or optical carriers; and/or any combination of the foregoing.

Although the present disclosure has been described in detail, it should be understood that various changes, substitutions, and alterations can be made hereto without departing from the spirit and the scope of the disclosure as defined by the appended claims. For example, in some embodiments the operations of switch 102 may also be conducted by switch 108, and vice-versa.

What is claimed is:

1. A method for preventing traffic loss, comprising:
transmitting user traffic over an automatic protection switching (“APS”) connection with revertive operation between a first switch and a second switch, the APS connection including a working path and a protect path;
determining that the working path on the APS connection has failed;
moving user traffic to the protect path of the APS connection;
initiating a wait-to-restore mode including a wait-to-restore time period associated with the first switch;
upon termination of the wait-to-restore time period of the first switch, maintaining traffic on the protect path until a message designating the working path is received on the protect path;
upon receiving a message designating the working path, switching user traffic to the working path.

2. The method of claim 1, further comprising:
during the wait-to-restore time period associated with the first switch, determining whether a message was received designating the working path;
based on the determination, terminating the wait-to-restore mode and switching user traffic to the working path before the expiration of the wait-to-restore time period of the first switch.

3. The method of claim 1, further comprising, during the wait-to-restore time period of the first switch, sending a message to the second switch designating the working path.

4. The method of claim 1, further comprising:
upon termination of the wait-to-restore time period of the first switch, entering the first switch into a state designated, according to the definitions of the G.8031 standard, as “B”; and
upon receiving a message designating the working path, entering the first switch into a state designated, according to the definitions of the G.8031 standard, as “A”.

5. The method of claim 1, wherein the second switch includes a wait-to-restore time period of different length than the wait-to-restore time period of the first switch.

6. The method of claim 1, wherein the second switch is configured to, at the end of a wait-to-restore time period of the second switch, switch user traffic to the working path.

7. An article of manufacture comprising:
a computer readable medium; and
computer-executable instructions carried on the computer readable medium, the instructions readable by a processor, the instructions, when read and executed, for causing the processor to:
transmit user traffic over an automatic protection switching (“APS”) connection with revertive operation between a first switch and a second switch, the APS connection including a working path and a protect path;
determine that the protect path on the APS connection has failed;
move user traffic to the protect path of the APS connection;
initiate a wait-to-restore mode including a wait-to-restore time period associated with the first switch;
upon termination of the wait-to-restore time period of the first switch, maintain traffic on the protect path until a message designating the working path is received on the protect path;
upon receiving a message designating the working path, switch user traffic to the working path.

8. The article of claim 7, wherein the instructions further cause the processor to:
during the wait-to-restore time period associated with the first switch, determine whether a message was received designating the working path;
based on the determination, terminate the wait-to-restore mode and switch user traffic to the working path before the expiration of the wait-to-restore time period of the first switch.

9. The article of claim 7, wherein the instructions further cause the processor to, during the wait-to-restore time period of the first switch, send a message to the second switch designating the working path.

10. The article of claim 7, wherein the instructions further cause the processor to:
upon termination of the wait-to-restore time period of the first switch, enter the first switch into a state designated, according to the definitions of the G.8031 standard, as “B”; and
upon receiving a message designating the working path, enter the first switch into a state designated, according to the definitions of the G.8031 standard, as “A”.

11. The article of claim 7, wherein the second switch includes a wait-to-restore time period of different length than the wait-to-restore time period of the first switch.

12. The article of claim 7, wherein the second switch is configured to, at the end of a wait-to-restore time period of the second switch, switch user traffic to the working path.

13. A system comprising:
a first switch comprising a computer readable medium and a processor coupled to the computer readable medium;
an automatic protection switching (“APS”) connection communicatively coupled to the first switch; and
computer-executable instructions carried on the computer readable medium, the instructions readable by the processor, the instructions, when read and executed, for causing the processor to:
transmit user traffic over an automatic protection switching (“APS”) connection with revertive operation between a first switch and a second switch, the APS connection including a working path and a protect path;
determine that the protect path on the APS connection has failed;
move user traffic to the protect path of the APS connection;
initiate a wait-to-restore mode including a wait-to-restore time period associated with the first switch;
upon termination of the wait-to-restore time period of the first switch, maintain traffic on the protect path until a message designating the working path is received on the protect path;
upon receiving a message designating the working path, switch user traffic to the working path.

14. The system of claim 13, wherein the instructions further cause the processor to:
during the wait-to-restore time period associated with the first switch, determine whether a message was received designating the working path;
based on the determination, terminate the wait-to-restore mode and switch user traffic to the working path before the expiration of the wait-to-restore time period of the first switch.

15. The system of claim 13, wherein the instructions further cause the processor to, during the wait-to-restore time period of the first switch, send a message to the second switch designating the working path.

16. The system of claim 13, wherein the instructions further cause the processor to:
upon termination of the wait-to-restore time period of the first switch, enter the first switch into a state designated, according to the definitions of the G.8031 standard, as “B”; and
upon receiving a message designating the working path, enter the first switch into a state designated, according to the definitions of the G.8031 standard, as “A”.

17. The system of claim 13, wherein the second switch includes a wait-to-restore time period of different length than the wait-to-restore time period of the first switch.

18. The system of claim 13, wherein the second switch is configured to, at the end of a wait-to-restore time period of the second switch, switch user traffic to the working path.
